(19) United States
(12) Patent Application Publication
(10) Pub. No.: US 2017/0309289 A1
(43) Pub. Date: Oct. 26, 2017

(54) METHODS, APPARATUSES AND COMPUTER PROGRAMS RELATING TO MODIFICATION OF A CHARACTERISTIC ASSOCIATED WITH A SEPARATED AUDIO SIGNAL

(71) Applicant: Nokia Technologies Oy, Espoo (FI)

(72) Inventors: Antti Eronen, Tampere (FI); Arto Lehtiniemi, Lempaala (FI); Jussi Leppänen, Tampere (FI); Francesco Cricri, Tampere (FI)

(21) Appl. No.: 15/486,603

(22) Filed: Apr. 13, 2017

(30) Foreign Application Priority Data
Apr. 26, 2016 (EP) 16166989.0

(51) Int. Cl. G10L 21/028; G10L 21/0308; G10L 21/02

(52) U.S. Cl. CPC G10L 21/028; G10L 21/0205; G10L 21/0308

(57) ABSTRACT

This specification describes a method comprising determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.

### FIELD

This specification relates to modification of a characteristic associated with a separated audio signal.

### BACKGROUND

Audio signal processing techniques allow identification and separation of individual sound sources from audio signals which include components from a plurality of different sounds sources. Once an audio signal representing an identified audio signal has been separated from the remainder of the signal, characteristics of the separated signal may be modified in order to provide different audible effects to a listener.

### SUMMARY

In a first aspect, this specification describes a method comprising determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.

The separated signal modification parameter may be a spatial repositioning parameter which indicates a range of spatial repositioning for spatial repositioning of the separated audio signal. Other examples of the characteristic associated with the separated audio signal may include but are not limited to amplitude, equalisation, reverberation, distortion and compression.

The method may comprise determining the measure of success of the separation of the audio signal from the composite audio signal.

The method may comprise limiting an allowed amount of modification of the characteristic associated with the separated audio signal based on the value of the separated signal modification parameter.

The method may comprise causing an indication of the determined value of the separated signal modification parameter to be provided to a user.

The method may comprise, when the measure of success indicates that success of the separation is above a threshold degree of success, determining a value of the separated signal modification parameter which indicates a full range of modification of the characteristic.

When the measure of success indicates that the success of the separation is below a threshold degree of success, the determined value of the separated signal modification parameter may indicate a range of modification which has a direct relationship with the degree of success.

The measure of success may comprise a correlation between a remainder of the composite audio signal and at least one reference audio signal. The at least one reference signal may comprise one or both of the separated audio signal and a signal derived from one of the additional recording devices which is associated with the audio source to which the separated audio signal relates. The method may further comprise, if the correlation is a below the predetermined threshold correlation, determining a value of the separated signal modification parameter which indicates a full range of modification, and, if the correlation is above the predetermined threshold correlation, determining a value of the separated signal modification parameter which indicates a range of modification which has an inverse relationship with the correlation.

In other examples, the measure of success of the separation may additionally or alternatively comprise a correlation between a frequency spectrum associated with the remainder of the composite audio signal and a frequency spectrum associated with the reference audio signal. In yet other examples, the measure of success of the separation may additionally or alternatively comprise a correlation between a remainder of composite audio signal and a component of a video signal corresponding to the composite audio signal.

The correlation between the remainder of the composite audio signal and the reference signal or between the remainder of the composite audio signal and the component of the video signal corresponding to the composite audio signal may have an inverse relationship with a degree of success of the separation.

The method may comprise responding to a determination that the measure of success of the separation indicates that, for a subsequent temporal frame of the composite audio signal, a degree of success of the separation is lower than the degree of success of the separation for a current temporal frame of the composite audio signal by spatially repositioning the separated audio signal to a position which is nearer to an original spatial position of the separated audio signal. The spatial repositioning of the separated audio signal to the position which is nearer to the original spatial position may be performed prior to rendering of the subsequent temporal frame of the composite audio signal.

The method may comprise causing performance of the separation of the audio signal representing the sound source from the composite audio signal.

The method may comprise repositioning the separated audio signal to a new spatial position based on the determined value of the spatial repositioning parameter.

In a second aspect, this specification describes apparatus configured to perform a method as described with reference to the first aspect.

In a third aspect, this specification describes computer-readable instructions which, when executed by computing apparatus, cause the computing apparatus to cause performance of a method as described with reference to the first aspect.

In a fourth aspect, this specification describes apparatus comprising at least one processor and at least one memory including computer program code, which when executed by the at least one processor, causes the apparatus to determine, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.

The separated signal modification parameter may be a spatial repositioning parameter which indicates a range of spatial repositioning for spatial repositioning of the separated audio signal. Other examples of the characteristic associated with the separated audio signal may include but are not limited to amplitude, equalisation, reverberation, distortion and compression.

The computer program code, when executed by the at least one processor, may cause the apparatus to determine the measure of success of the separation of the audio signal from the composite audio signal.

The computer program code, when executed by the at least one processor, may cause the apparatus to limit an allowed amount of modification of the characteristic associated with the separated audio signal based on the value of the separated signal modification parameter.

The computer program code, when executed by the at least one processor, may cause the apparatus to cause an indication of the determined value of the separated signal modification parameter to be provided to a user.

The computer program code, when executed by the at least one processor, may cause the apparatus, when the measure of success indicates that success of the separation is above a threshold degree of success, to determine a value of the separated signal modification parameter which indicates a full range of modification of the characteristic.

When the measure of success indicates that the success of the separation is below a threshold degree of success, the determined value of the separated signal modification parameter may indicate a range of modification which has a direct relationship with the degree of success.

The measure of success may comprise a correlation between a remainder of the composite audio signal and at least one reference audio signal. The at least one reference signal may comprise one or both of the separated audio signal and a signal derived from one of the additional recording devices which is associated with the audio source with which the separated audio signal corresponds. The computer program code, when executed by the at least one processor, may cause the apparatus, if the correlation is a below the predetermined threshold correlation, to determine a value of the separated signal modification parameter which indicates a full range of modification, and, if the correlation is above the predetermined threshold correlation, to determine a value of the separated signal modification parameter which indicates a range of modification which has an inverse relationship with the correlation.

In other examples, the measure of success of the separation may additionally or alternatively comprise a correlation between a frequency spectrum associated with the remainder of the composite audio signal and a frequency spectrum associated with the reference audio signal. In yet other examples, the measure of success of the separation may additionally or alternatively comprise a correlation between a remainder of composite audio signal and a component of a video signal corresponding to the composite audio signal.

The correlation between the remainder of the composite audio signal and the reference signal or between the remainder of the composite audio signal and the component of the video signal corresponding to the composite audio signal may have an inverse relationship with a degree of success of the separation.

The computer program code, when executed by the at least one processor, may cause the apparatus to respond to a determination that the measure of success of the separation indicates that, for a subsequent temporal frame of the composite audio signal, a degree of success of the separation is lower than the degree of success of the separation for a current temporal frame of the composite audio signal by spatially repositioning the separated audio signal to a position which is nearer to an original spatial position of the separated audio signal. The spatial repositioning of the separated audio signal to the position which is nearer to the original spatial position may be performed prior to rendering of the subsequent temporal frame of the composite audio signal.

The computer program code, when executed by the at least one processor, may cause the apparatus to cause performance of the separation of the audio signal representing the sound source from the composite audio signal.

The computer program code, when executed by the at least one processor, may cause the apparatus to reposition the separated audio signal to a new spatial position based on the determined value of the spatial repositioning parameter.

In a fifth aspect, this specification describes a computer-readable medium having computer-readable code stored thereon, the computer readable code, when executed by a least one processor, causing performance of at least: determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal. The computer-readable code stored on the medium of the fifth aspect may further cause performance of any of the operations described with reference to the method of the first aspect.

In a sixth aspect, this specification describes apparatus comprising: means for determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal. The apparatus of the sixth aspect may further comprise means for causing performance of any of the operations described with reference to method of the first aspect.

In an eighth aspect, this specification describes a method comprising causing display of at least one indicator for indicating a value of a separated signal modification parameter, the value of the separated signal modification parameter indicating a range of modification of a characteristic associated with an audio signal representing a sound source which has been separated from a composite audio signal comprising components derived from at least two sound sources, wherein the value of the separated signal modification parameter is based on a determined measure of success of the separation of the audio signal representing the sound source from the composite audio signal.

In a ninth aspect, this specification describes a graphical user interface comprising: at least one graphical indicator for indicating a value of a separated signal modification parameter, the value of the separated signal modification parameter indicating a range of modification of a characteristic associated with an audio signal representing a sound source which has been separated from a composite audio signal comprising components derived from at least two sound sources, wherein the value of the separated signal modification parameter is based on a determined measure of success of the separation of the audio signal representing the sound source from the composite audio signal.

### BRIEF DESCRIPTION OF THE FIGURES

For better understanding of the present application, reference will be made by way of example to the accompanying drawings in which:

FIG. 1 is an example of an audio capture system which may be used in order to capture audio signals for processing in accordance with various examples described herein;

FIGS. 2A to 2C are flow charts illustrating various operations which may be performed by the audio processing apparatus depicted in FIG. 1;

FIG. 3A is an example of a graphical user interface which may be provided thereby to indicate to a user a value of a separated signal modification parameter;

FIG. 3B is another example of a graphical user interface which may be provided thereby to indicate to a user a value of a separated signal modification parameter;

FIG. 3C is another example of a graphical user interface which may be provided thereby to indicate to a user a value of a separated signal modification parameter

FIGS. 4A to 4C illustrate various concepts described herein in relation to spatial repositioning of separated audio signals; and

FIG. 5 is a schematic illustration of an example configuration of the audio processing apparatus depicted in FIG. 1.

### DETAILED DESCRIPTION OF EMBODIMENTS

In the description and drawings, like reference numerals refer to like elements throughout.

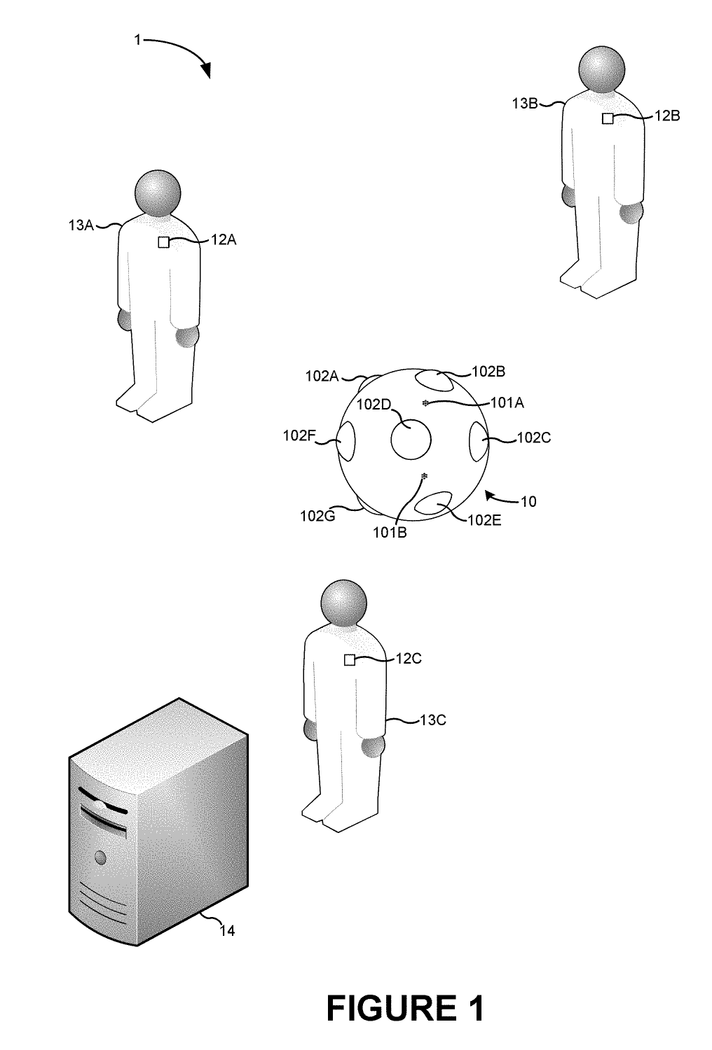

FIG. 1 is an example of an audio capture system 1 which may be used in order to capture audio signals for processing in accordance with various examples described herein. In this example, the system 1 comprises a spatial audio capture apparatus 10 configured to capture a spatial audio signal, and one or more additional audio capture devices 12A, 12B, 12C.

The spatial audio capture apparatus 10 comprises a plurality of audio capture devices 101A, B (e.g. directional or non-directional microphones) which are arranged to capture audio signals which may subsequently be spatially rendered into an audio stream in such a way that the reproduced sound is perceived by a listener as originating from at least one virtual spatial position. Typically, the sound captured by the spatial audio capture apparatus 10 is derived from plural different sound sources which may be at one or more different locations relative to the spatial audio capture apparatus 10. As the captured spatial audio signal includes components derived from plural different sounds sources, it may be referred to as a composite audio signal. Although only two audio capture devices 102A, B are visible in FIG. 1, the spatial audio capture apparatus 10 may comprise more than two devices 102A, B. For instance, in some specific examples, the audio capture apparatus 10 may comprise may comprise eight audio capture devices.

In the example of FIG. 1, the spatial audio capture apparatus 10 is also configured to capture visual content (e.g. video) by way of a plurality of visual content capture devices 102A-G (e.g. cameras). The plurality of visual content capture devices 102A-G of the spatial audio capture apparatus 10 may be configured to capture visual content from various different directions around the apparatus, thereby to provide immersive (or virtual reality content) for consumption by users. In the example of FIG. 1, the spatial audio capture apparatus 10 is a presence-capture device, such as Nokia's OZO camera. However, as will be appreciated, the spatial audio capture apparatus 10 may be another type of device and/or may be made up of plural physically separate devices. As will also be appreciated, although the content captured may be suitable for provision as immersive content, it may also be provided in a regular non-VR format for instance via a smart phone or tablet computer.

As mentioned previously, in the example of FIG. 1, the spatial audio capture system 1 further comprises one or more additional audio capture devices 12A-C. Each of the additional audio capture devices 12A-C may comprise at least one microphone and, in the example of FIG. 1, the additional audio capture devices 12A-C are lavalier microphones configured for capture of audio signals derived from an associated user 13A-C. For instance, in FIG. 1, each of the additional audio capture devices 12A-C is associated with a different user by being affixed to the user in some way. However, it will be appreciated that, in other examples, the additional audio capture devices 12A-C may take a different form and/or may be located at fixed, predetermined locations within an audio capture environment.

The locations of the additional audio capture devices 12A-C and/or the spatial audio capture apparatus 10 within the audio capture environment may be known by, or may be determinable by, the audio capture system 1 (for instance, the audio processing apparatus 14). For instance, in the case of mobile audio capture devices/apparatuses, the devices/apparatuses may include location determination component for enabling the location of the devices/apparatuses to be determined. In some specific examples, a radio frequency location determination system such as Nokia's High Accuracy Indoor Positioning may be employed, whereby the additional audio capture devices 12A-C (and in some examples the spatial audio capture apparatus 10) transmit messages for enabling a location server to determine the location of the additional audio capture devices within the audio capture environment. In other examples, for instance when the additional audio capture devices 12A-C are static, the locations may be pre-stored by an entity which forms part of the audio capture system 1 (for instance, audio processing apparatus 14).

In the example of FIG. 1, the audio capture system 1 further comprises audio processing apparatus 14. The audio processing apparatus 14 is configured to receive and store signals captured by the spatial audio capture apparatus 10 and the one or more additional audio capture devices 12A-C. The signals may be received at the audio processing apparatus 14 in real-time during capture of the audio signals or may be received subsequently for instance via an intermediary storage device. In such examples, the audio processing apparatus 14 may be local to the audio capture environment or may be geographically remote from the audio capture environment in which the audio capture apparatus 10 and devices 12A-C are provided. In some examples, the audio processing apparatus 14 may even form part of the spatial audio capture apparatus 10.

The audio signals received by the audio signal processing apparatus 14 may comprise a multichannel audio input in a loudspeaker format. Such formats may include, but are not limited to, a stereo signal format, a 4.0 signal format, 5.1 signal format and a 7.1 signal format. In such examples, the signals captured by the system of FIG. 1 may have been pre-processed from their original raw format into the loudspeaker format. Alternatively, in other examples, audio signals received by the audio processing apparatus 14 may be in a multi-microphone signal format, such as a raw eight channel input signal. The raw multi-microphone signals may, in some examples, be pre-processed by the audio processing apparatus 14 using spatial audio processing techniques thereby to convert the received signals to loudspeaker format or binaural format.

In some examples, the audio processing apparatus 14 may be configured to mix the signals derived from the one or more additional audio capture devices 12A-C with the signals derived from the spatial audio capture apparatus 10. For instance, the locations of the additional audio capture devices 12A-C may be utilized to mix the signals derived from the additional audio capture devices 12A-C to the correct spatial positions within the spatial audio derived from the spatial audio capture apparatus 10. The mixing of the signals by the audio processing apparatus 14 may be partially or fully-automated.

The audio processing apparatus 14 may be further configured to perform (or allow performance of) spatial repositioning within the spatial audio captured by the spatial audio capture apparatus 10 of the sound sources captured by the additional audio capture devices 12A-C.

Spatial repositioning of sound sources may be performed to enable future rendering in three-dimensional space with free-viewpoint audio in which a user may choose a new listening position freely. Also, spatial repositioning may be used to separate sound sources thereby to make them more individually distinct. Similarly, spatial repositioning may be used to emphasize/de-emphasize certain sources in an audio mix by modifying their spatial position. Other uses of spatial repositioning may include, but are certainly not limited to, placing certain sound sources to a desired spatial location, thereby to get the listeners attention (these may be referred to as audio cues), limiting movement of sound sources to match a certain threshold, and widening the mixed audio signal by widening the spatial locations of the various sound sources. Various techniques for performance of spatial repositioning are known in the art and so will not be in detail herein. One example of a technique which may be used involves calculating the desired gains for a sound source using Vector Base Amplitude Panning (VBAP) when mixing the audio signals in the loudspeaker signal domain.

One issue to be addressed when performing spatial repositioning is the fact that the spatial audio captured by the spatial audio capture apparatus 10 will typically include components derived from the sound source which is being repositioned. As such, it may not be sufficient to simply move the signal captured by an individual additional audio capture device 12A-C. Instead, the components from the resulting sound source should also be separated from the spatial (composite) audio signal captured by the spatial audio apparatus 10 and should be repositioned along with the signal captured by the additional audio capture device 12A-C. If this is not performed, the listener will hear components derived from the same sound source as coming from different locations, which is clearly undesirable.

Various techniques for identification and separation of individual sound sources (both static and moving) from a composite signal are known in the art and so will not be discussed in much detail in this specification. Briefly, the separation process typically involves identifying/estimating the source to be separated, and then subtracting or otherwise removing that identified source from the composite signal. The removal of the identified sound source might be performed in the time domain by subtracting a time-domain signal of the estimated source, or in the frequency domain. An example of a separation method which may be utilized by the audio processing apparatus 14 is that described in pending patent application PCT/EP2016/051709 which relates to the identification and separation of a moving sound source from a composite signal and is hereby incorporated by reference. Another method which may be utilized may be that described in WO2014/147442 which describes the identification and separation of a static sound source and which is also incorporated by reference.

Regardless of how the sound sources are identified, once they have been identified, they may be subtracted or inversely filtered from the composite spatial audio signal to provide a separated audio signal and a remainder of the composite audio signal. Following spatial repositioning (or other modification) of the separated audio signal, the modified separated signal may be remixed back into the remainder of the composite audio signal to form a modified composite audio signal.

Separation of an individual sound source from a composite audio signal may not be particularly straightforward and, as such, it may not be possible in all instances to fully separate an individual sound source from the composite audio signal. In such instances, some components derived from the sound source which is intended for separation may remain in the remainder composite signal following the separation operation.

When the separation is not fully successful, and the separated signal is mixed back into the remainder of the composite audio signal at a repositioned location, the quality of the resulting audio representation that is experienced by the user may be degraded. For instance, in some examples, the user may hear the sound source at an intermediate position between the original location of the sound source and the intended re-positioned location. In other examples, the user may hear two distinct sounds sources, one at the original location and one at the re-positioned location. The effect experienced by the user may depend on the way in which the separation was unsuccessful. For instance, if a residual portion of all or most frequency components of the sound source remain in the composite signal following separation, the user may hear the sound source at the intermediate location. Two distinct sound sources may be heard when only certain frequency components (part of the frequency spectrum) of the sound source remain in the composite signal, with other frequency components being successfully separated. As will be appreciated, either of these effects may be undesirable and, as such, on occasions in which the separation of the audio signal is not fully successful, it may be beneficial to limit the range of spatial repositioning that is available.

In view of this fact, the audio processing apparatus 14 is configured to determine a value of a separated signal modification parameter based on a determined measure of success of a separation of an audio signal representing a sound source from a composite audio signal, the composite audio signal comprising components derived from at least two sound sources. The value of the separated signal modification parameter (which may be referred to as simply the modification parameter) indicates a range for modification of a characteristic of the separated audio signal representing the sound source. The range may correspond to an amount of modification of the characteristic of the separated signal beyond which the quality of a modified composite audio signal (into which has been mixed the modified separated signal) falls below an acceptable level.

In some examples, the modification parameter may comprise a spatial repositioning parameter which indicates a spatial repositioning range for the spatial repositioning of the separated audio signal. Put another way, the characteristic of the separated signal that is to be modified may be the spatial position in audio space. In other examples, the modification parameter may comprise an amplitude modification parameter which may indicate a range of amplitude modification for the separated audio signal. Put another way, the characteristic to be modified may be the amplitude of the separated audio signal. Other examples of the characteristic of the spatial signal which may be modified in accordance with the separation success may include equalization, reverberation, distortion and compression. Levels of reverberation applied to a separated signal and the volume of the signal may be utilised to indicate a distance of a sound source from the user. For instance, increasing the reverberation and decreasing the volume may give the impression that the sound source is further from the listener. Conversely, decreasing the reverberation and increasing the volume may indicate that the sound source is closer to the listener. In yet other examples, the characteristic associated with the separated signal may comprise a range of allowed repositioning of the listening position during free viewpoint audio rendering. As such, an allowed range of repositioning of the listening position may be dependent on the separation success.

In order to enable the value of the modification parameter to be determined, the audio processing apparatus 14 may be configured to determine the measure of success of the separation of the audio signal representing the sound source. However, in other examples, the measure of separation success may be determined by another entity within the system and may be provided to the audio processing apparatus 14, for instance along with the audio signals.

The audio processing apparatus 14 may be further configured to limit an allowed amount of modification of the characteristic of the separated audio signal based on the value of a modification parameter. In this way, modification of the separated signal outside the range indicated by the modification parameter may be prevented. This may prevent an unacceptable degree of degradation of the modified composite audio signal.

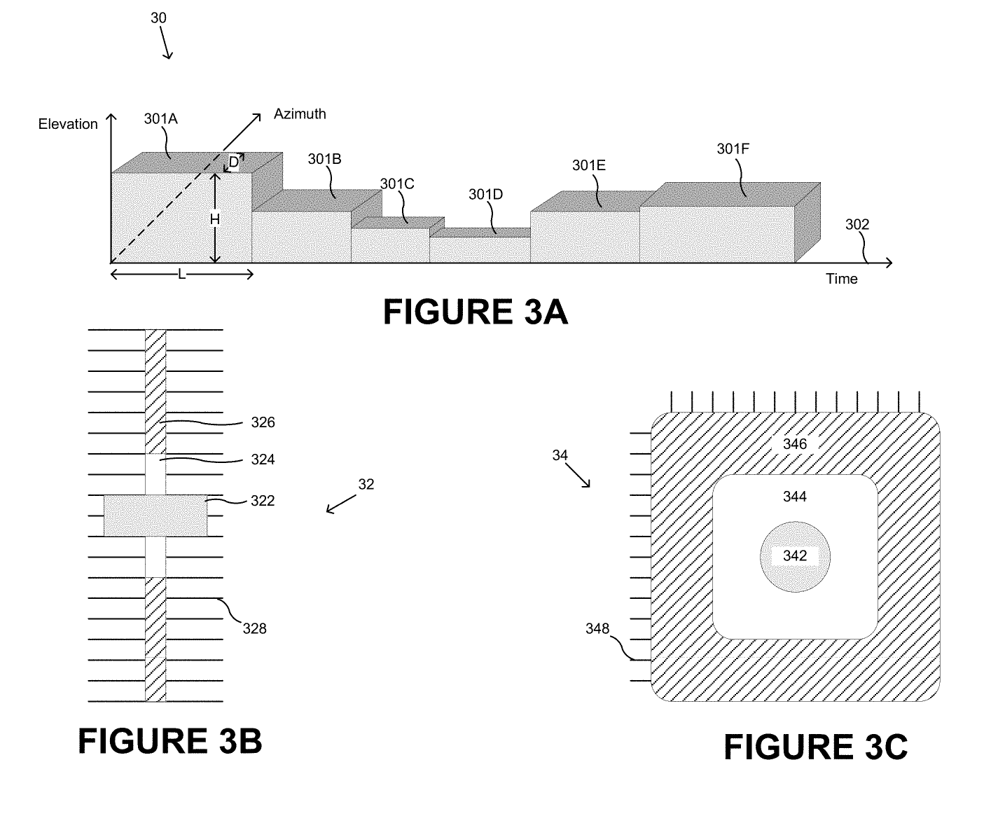

The audio processing apparatus 14 may be further configured to cause an indication of the determined value of the modification parameter to be provided to a user, for instance via a graphical user interface. The graphical user interface may be configured to visually indicate in some way, the value of the modification parameter to a user. Various examples of suitable graphical user interfaces are discussed below with reference to FIGS. 3A, 3B and 3C.

The audio processing apparatus 14 may be configured such that, when the measure of success indicates that success of the separation is above a threshold degree of success, the determined value of the modification parameter indicates that a full range of modification of a particular characteristic of the separated signal may be performed. In examples in which the modification relates to spatial repositioning, the full range of spatial repositioning may depend on the configuration of the spatial audio capture apparatus 10. For instance, if the spatial audio capture apparatus 10 is configured to capture spatial audio in 360 degrees surrounding the device, the full range of repositioning may be 360 degrees. However, if the spatial audio capture apparatus 10 is configured to capture spatial audio from less than 360 degrees (e.g. 180 degrees) around the apparatus 10, the full range of repositioning may be limited to that amount.

Conversely, when the measure of success indicates that the success of the separation is below a threshold degree of success, the audio processing apparatus 10 may be configured such that the determined value of the modification parameter has a direct relationship with the degree of success. Put another way, the range of modification indicated by the value of the parameter may increase and decrease as the degree of success increases and decreases.

The measure of success, in certain examples may comprise a determined correlation between a remainder of the composite audio signal and at least one reference audio signal. The reference audio signal may, in some examples, be the separated audio signal. In such examples, the audio processing apparatus 10 may thus be configured to determine a correlation between a portion of the remainder of the composite audio corresponding to the original location of the separated signal and the separated audio signal. A high correlation may indicate that the separation has not been particularly successful (a low degree of success), whereas a low (or no) correlation may indicate that the separation has been successful (a high degree of success). It will thus be appreciated that, in such examples, the correlation (which is an example of the determined measure of success of the separation) may have an inverse relationship with the degree of success of the separation.

In other examples, the reference signal may comprise a signal captured by one of the additional recording devices 12A, for instance the additional recording devices that is associated with the audio source with which the separated signal is associated. This approach may be useful for determining separation success when the separation has resulted in the audio spectrum associated with the sound source being split between the remainder of the composite signal and the separated signal. Once again, the correlation may have an inverse relationship with the degree of success of the separation.

In some examples, both the correlation between the composite audio signal and the separated signal and the correlation between the composite audio signal and the signal derived from the additional recording device may be determined and utilised to determine the separation success. If either of the correlations is above a threshold, it may be determined that the separation has not been fully successful.

The correlation may be determined using the following expression:

$$Correlation ( τ , n ) = {\sum }_{K = 0}^{n} R ( k ) S ( k - τ )$$

where R(k) and S(k) are the k^{th} samples from remainder of the composite signal and the reference signal respectively, r is the time lag and n is the total number of samples.

The audio processing apparatus 14 may be configured to compare the determined correlation with a predetermined correlation threshold and, if the correlation is a below the predetermined threshold correlation, to determine that the separation has been fully (or sufficiently) successful. Conversely, if the correlation is above the predetermined threshold correlation, the audio processing apparatus 14 may be configured to determine that the separation has not been fully (or sufficiently) successful or, put another way, has been only partially successful.

As an alternative to the expression shown above, the measure of success of the separation, in some examples, may comprise a correlation between a frequency spectrum associated with the remainder of the composite audio signal and a frequency spectrum associated with at least one reference audio signal. If frequency components from the reference audio signal are also present in the remainder of the composite audio signal, it can be inferred that the separation has not been fully successful. In contrast, if there is no correlation between frequency components in the separated audio signal and the remainder of the composite audio signal it may be determined that the separation has been fully successful. As described above, the at least one reference audio signal may comprise one or both of the separated audio signal and a signal derived from one of the additional recording devices.

In other examples, however, the measure of success of the separation may comprise a correlation between a remainder of composite audio signal and a component of a video signal corresponding to the composite audio signal. For instance, in examples in which the sound source is derived from a person talking, the audio processing apparatus 14 may determine whether the remainder of the composite audio signal includes components having timing which correspond to movements of the mouth of the person from which the sound source is derived. If such audio components do exist, it may be determined that the separation has not been fully successful, whereas if such audio components do not exist it may be determined that the separation has been fully successful.

As will be appreciated, in all of the examples described above, the determined correlation has an inverse relationship with a degree of success of the separation.

In some examples, the audio processing apparatus 14 may be configured to modify a characteristic of the separated audio signal based on the determined value of the modification parameter. For instance, the audio processing apparatus 14 may be configured to respond to a determination that the measure of success of the separation indicates that, for a subsequent temporal frame, a degree of separation success is lower than the degree of separation success of a current temporal frame by modifying the characteristic of the separated audio signal to a value which is nearer to an original value of the characteristic of the separated audio signal. In such examples, the modification of the characteristic of the separated audio signal to the value which is nearer to the original value is performed prior to the onset of the rendering of the subsequent temporal frame of the modified composite audio signal. The modification of the characteristic to the value nearer the original value may be performed gradually such that the user does not experience a sudden significant change in the value of the characteristic at the onset of the rendering of the subsequent temporal frame of the modified composite audio signal.

As will be understood, a temporal frame may be a segment of digitized audio signal y(n), for example, y(n) . . . y(n+M), where M is the length of the window. For example, M may equal 2048 samples or any other suitable value. The size of the temporal frame may be pre-defined and may in some examples be dependent on the type or nature of the composite signal. For instance, a composite signal having a first type (e.g. made up of people speaking) may be analysed with first temporal frame length and a composite signal having a second type (e.g. music) may analysed with a second temporal frame length. In such examples, the first and second temporal frame lengths may have been defined based on tests as to which frame length yields the best separation success, on average, for a particular type of signal.

The frame length used during separation and frame length used during rendering may not be equal to one another. For instance, the separation could be performed using frames of 2048 samples in length, whereas the rendering could be performed using frames of 512 samples in length.

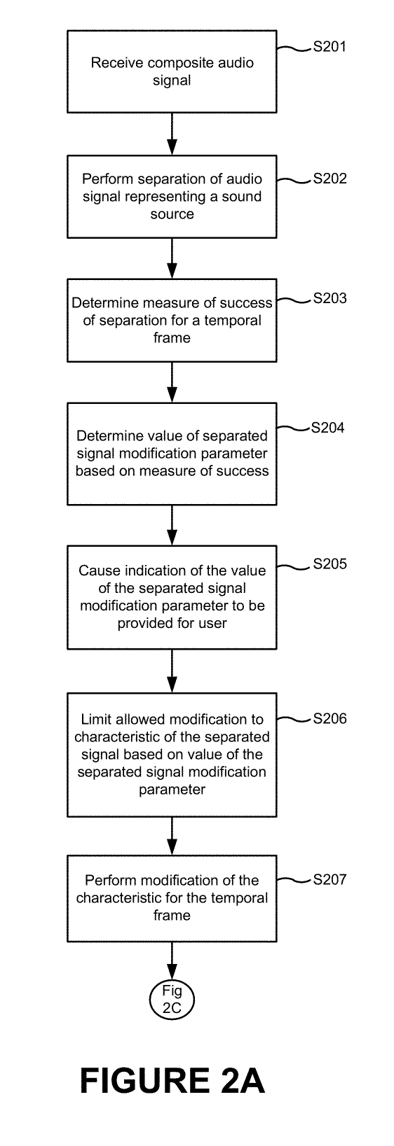

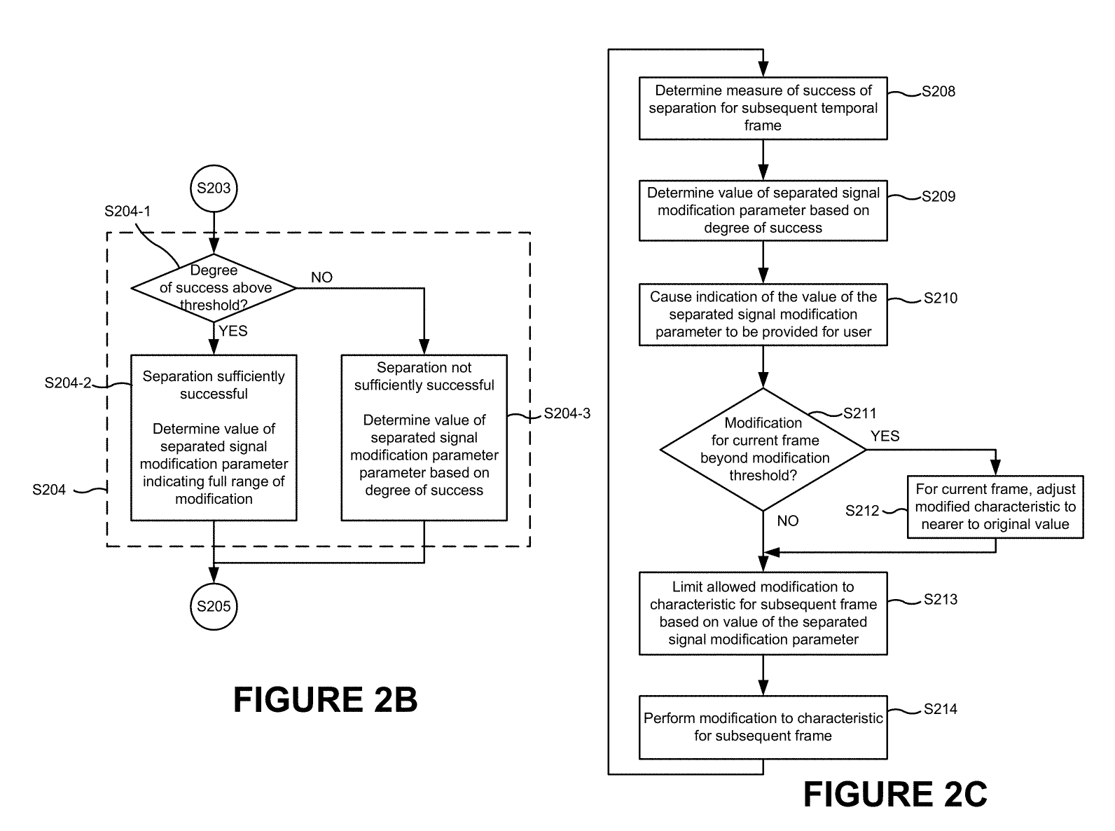

FIG. 2A is a flowchart illustrating various operations which may be performed by audio processing apparatus 14 such as that depicted in FIG. 1.

In operation S201, the audio processing apparatus 14 receives a representation of the composite audio signal. As discussed previously, the representation may be received in any of various different formats. Although not depicted in FIG. 1, depending on the format in which the representation is received, the audio processing apparatus 14 may in some examples perform preprocessing to reformat the composite audio signal into another format.

In operation S202, the audio processing apparatus 14 performs separation of a portion of the composite audio signal which represents a sound source from the composite audio signal. The separation may be performed in any suitable manner, for instance as described in either of PCT/EP2016/051709 and WO2014/147442.

After performing the separation, the audio processing apparatus 14, in operation S203, computes a measure of success of the separation of the separated audio signal from the composite audio signal. As discussed above, the measure of success may be in the form of a calculated correlation between the remainder of the composite audio signal and either at least one reference audio signal or a portion of a video component corresponding to the composite audio signal. As discussed above, the at least one reference audio signal may comprise one or both of the separated audio signal and a signal derived from one of the additional recording devices that is associated with the audio source to which the separated signal relates.

As will of course be appreciated, properties of the composite audio signal may change over time (for instance, but not exclusively due to movement of the sound sources within the audio capture environment). As such, the success with which a sound source is able to be separated from the composite audio signal may vary over time. Consequently, operation S203, as well as operations S204 to S207, may be performed for individual segments (or temporal frames) of the composite audio signal.

In examples in which the audio processing apparatus 14 is configured to compute the correlation between the remainder of the composite audio signal and the reference audio signal, the correlation may be correlation in either of the time domain or the frequency domain. When the correlation is computed in the frequency domain, the frequency spectrum of the reference audio signal may be compared with a frequency spectrum of the remainder of the composite audio signal.

In examples in which the audio processing apparatus 14 is configured to compute the correlation between the remainder of the composite audio signal and a portion of a video component corresponding to the composite audio signal this may be determined by first identifying a portion of the video component which corresponds to the original spatial location of the separated audio signal. Next, the video component is examined to determine if there are any features present in the portion of the video component which are time-synchronized with components of the remainder of the composite audio signal. For instance, the audio processing apparatus 14 may determine whether the movement of a person's mouth is synchronized with audio components of the remainder of the composite audio signal.

Regardless of which correlation is determined by the audio processing apparatus 14, a high degree of correlation may indicate a low degree of success of the separation, whereas a low degree of correlation may indicate a high degree of success of the separation. Put another way, an inverse relationship may exist between the calculated correlation and the degree of success of the separation.

After calculating the measure of success of the separation, the audio processing apparatus 14 may proceed to operation S204 in which it determines the value of the separated signal modification parameter, which indicates a range for modification of a characteristic of the separated audio signal. For instance, in some examples, the value of the modification parameter may comprise a maximum value to which a characteristic may be modified without degrading a quality of the modified composite audio signal beyond an acceptable level. In other examples, however, the value of the modification parameter may comprise an allowed range of modification which may be performed without degrading a quality of the modified composite audio signal beyond an acceptable level. As discussed previously, the extent of modification indicated by the value of the modification parameter may have a direct relationship with the degree of success of the separation and an inverse relationship with the calculated correlation.

Examples of various sub-operations which may constitute operation S204 are illustrated in and discussed with reference to the flow chart of FIG. 2B.

In operation S204-1, the audio processing apparatus 14 may determine whether the measure of success of the separation (as determined in operation S203) indicates that the degree of success is above a success threshold. In some examples, this operation may comprise comparing the calculated correlation with a threshold correlation. In such examples, if the calculated correlation is above a correlation threshold, it may be determined that the degree of success is below the success threshold. Conversely, if it is determined that calculated correlation is below the correlation threshold, it may be determined that the degree of success of the separation is above a success threshold.

If, in operation S204-1, it is determined that the success of the separation is above the success threshold, the audio processing apparatus 14 may proceed to operation S204-2 in which it is determined that the separation was sufficiently successful and as such that the value of the modification parameter is to indicate that a full range of modification may be performed. The extent of modification that corresponds to the “full range” may be pre-programmed into the audio processing apparatus 14

Conversely, if, in operation S204-1, it is determined that the success of the separation is below the success threshold, the audio processing apparatus 14 may proceed to operation S204-3 in which it is determined that the separation was not sufficiently successful and so may determine the value of the modification parameter in dependence on the degree of success. For instance, when the degree of success is below the threshold, the value of the modification parameter may indicate a larger range of modification for a higher degree of success and may indicate a smaller range of modification for a lower degree of success.

Returning now to FIG. 2A, in operation S205, the audio processing apparatus 14 may cause the value of the modification parameter to be indicated via a graphical user interface to a user. This may enable the user to determine the range of modification which may be performed without degrading the quality of the modified composite signal beyond an acceptable level.

In operation S206, the audio processing apparatus 14 may impose a limit on the amount modification which may be performed in respect of the separated audio signal. As such, the audio processing apparatus 14 may be configured to prevent modification of the characteristic beyond the range indicated by the value of the modification parameter. In this way, a user may be able only to modify the characteristic, for instance via the graphical user interface within an allowed range.

In operation S207, the audio processing apparatus 14 may be configured to perform a modification of the characteristic of the separated audio signal. The modification may be performed in respect of the temporal frame to which the degree of spatial success relates. The modification may be performed in response to an input by the user indicating a desired extent of modification. In view of the imposed limit on the extent of the allowed modification, the modification may be limited based on the value of the modification parameter. As such, in some examples, if the user indicates a desired modification which is outside the allowed range, the audio processing apparatus 14 may respond by modifying the characteristic to a maximum extent indicated by the value of the modification parameter even though this is less than the desired modification.

FIG. 2C is a flowchart illustrating various other operations which may be performed by audio processing apparatus 14 such as that depicted in FIG. 1. The operations illustrated in FIG. 2C may be performed subsequent to performance of operation S207 and may be performed in respect of a temporal frame of the composite audio signal that is subsequent in time to the temporal frame in respect of which operations S203 to S207 of FIG. 2A were performed.

In operation S208, the measure of success of separation of the audio signal from the subsequent temporal frame of the composite audio signal may be determined. This may be performed in any of the ways described with reference to operation S203.

Next, in operation, S209, the audio processing apparatus 14 determines a value of the modification parameter for the subsequent temporal frame of the composite audio signal. This may be performed as described in relation to operation S204 in FIGS. 2A and 2B.

In operation S210, the value of the modification parameter for the subsequent portion may be indicated to the user via a graphical user interface (examples of which will be discussed in more detail with reference to FIGS. 3A, 3B and 3C).

In operation S211, the audio processing apparatus 14 determines whether a degree of modification of the characteristic for the preceding temporal frame exceeds the threshold indicated by the value of the modification parameter for the subsequent temporal frame (which was determined in operation S209).

If a positive determination is reached in operation S211, the audio processing apparatus 14 proceeds to operation S212. In operation S212, the audio processing apparatus 14, during rendering of the preceding temporal frame of the modified composite audio signal, causes the degree of modification to the characteristic of the separated signal to be reduced to a level that is within the range indicated by the value of the modification parameter for the subsequent temporal frame. Put another way, the performance of operation S212 may be prior to the onset of the rendering of the subsequent temporal frame of the separated audio signal. The modification to the reduced level may be performed gradually as the as the preceding portion is rendered. In this way, the user does not experience a sudden significant jump in the value of the modified characteristic. After performance of operation S211, the audio processing apparatus 14 may proceed to operation S212.

If it is determined in operation S211 that the degree of modification of the characteristic for the preceding temporal frame does not exceed the threshold indicated by the value of the modification parameter for the subsequent temporal frame, the audio processing apparatus 14 proceeds to operation S212.

In operation S213, during rendering of the subsequent temporal frame of the modified composite audio signal, the audio processing apparatus 14 imposes a limit on the allowed modification. This may be as described with reference to operation S206.

In operation S214, if, for instance, a user input indicating another modification of the characteristic is received, the audio processing apparatus 14 may respond by modifying the characteristic accordingly. This may be performed as described with reference to operation S207. As will be appreciated, if no input requiring modification of the characteristic is received, operation S214 may be skipped.

Subsequently, the audio processing apparatus 14 returns to operation S208 in which the measure of success of the separation is determined for a subsequent temporal frame of the received composite audio signal.

As will of course be appreciated, the operations depicted in FIGS. 2A to 2C are examples only. As such, the operations may be performed in a different order, certain operations may be omitted and/or additional operations may be performed. For instance, although various determinations have been described as being performed on a frame-by-frame basis, in other examples, a measure of the separation success may be determined over an extended period, with the temporal frames utilized for the purposes of operations S211 to S214 being determined based on the measure of separation success In such examples, each temporal frame may be selected such that within the temporal frame the measure of separation success is relatively uniform, with the boundaries between temporal frames corresponding to times at which there is a significant change (e.g. a change which is greater than a threshold) in the measure of success of the separation.

FIG. 3A is an example of a graphical user interface (GUI) 30 via which a value of the modification parameter for one or more temporal frames of composite audio signal may be indicated to the user.

The GUI 30, in the example of FIG. 3A, includes one or more indicators 301A-F each corresponding to a different temporal frame of the composite audio signal. The indicators 301 are configured to indicate the value of the modification parameter that is determined for each signal frame, thereby to indicate an allowed degree of modification.

In some examples, such as that of FIG. 3A, the indicators 301 may additionally indicate a duration of the temporal frame. In the example of FIG. 3A, a first dimension L (e.g. length) of the indicators 301A-F indicates the duration of each temporal frame. More specifically, a longer first dimension indicates a temporal frame with a longer duration. In the example of FIG. 3A, the indicators are provided on a timeline, such that temporal frames corresponding to later portions of the incoming composite signal are provided further along the timeline than are temporal frames corresponding to earlier portions of the incoming composite signal.

A second dimension H (e.g. height) of the indicators may indicate the value of the modification parameter, such that a greater height indicates a greater degree of allowed modification for the temporal frame. For instance, in FIG. 3A, the heights of the indicators successively decrease from that corresponding to first temporal frame to that corresponding to the fourth temporal frame. This may indicate that the value of the modification parameter successively decreases from the first to fourth temporal frames and consequently that the allowed range of modification also decreases from the first to fourth temporal frames.

In some instances, such as that of FIG. 3A, the indicators 301A-F may indicate values of two different modification parameters. In such examples, a third dimension D (e.g. depth) of the indicators 301A-F may indicate a value of the second modification parameter. For instance, in the example of FIG. 3A, the modification parameter(s) are spatial repositioning parameters, with a first parameter corresponding to azimuthal spatial repositioning and a second parameter corresponding to elevational spatial repositioning. In the example of FIG. 3A, the value of the azimuthal spatial repositioning parameter is indicated by the depth of the indicator and the value of the elevational spatial repositioning parameter is indicated by the height of the indicators.

FIGS. 3B and 3C illustrate examples of other GUI aspects 32, 34 via which a value of the modification parameter for one or more temporal frames of composite audio signal may be indicated to the user.

In these examples, the GUIs 32, 34 include a moveable element 322, 342, the location of which indicates the current degree of modification of the characteristic (e.g. spatial position) that is applied.

Each GUI 32, 34 may further include at least one delineated first region 324, 344 indicating a range of modification which is “allowed” (thereby indicating the value of the modification parameter). The GUI 32, 34 may also include a second region 326, 346 indicating degrees of modification outside the “allowed” range. The two regions may be visually distinct from one another (for instance, using different colours, e.g. green and red). The GUIs 32, 34 may additionally include demarcations 328, 348 indicating the degree of modification in quantitative terms.

The GUI 32 of FIG. 3B is configured for indicating modification in just one dimension (for instance, where the modification relates to spatial positioning, only the azimuth). The GUI 34 of FIG. 3C, on the other hand, is configured for indicating modification in two dimensions (e.g. azimuth and elevation) where location of the moveable element 342 in either of the x and y direction corresponds to modification in a different dimension. As will of course be appreciated, two (or three) GUIs such as that of FIG. 3B may be provided in tandem thereby to indicate modification in two (or three) dimensions.

In some examples, the GUIs 32, 34 may be displayed on a touch-enabled interface, whereby the user provides touch inputs to move the moveable element 322, 324 and thereby to modify the characteristic of the separated signal. In other examples, however, the GUIs may be usable with mechanical input devices such as mechanical sliders or mechanical toggles/joysticks 32, 34, wherein the movable element may be caused to move via the slider, toggle etc. In such examples, actuators may be utilized to provide inertial feedback to the mechanical devices, thereby to prevent or discourage modification of the characteristic beyond the indicated “allowed” range. In other examples, the physical feedback may be utilized with mechanical control devices (e.g. sliders, toggles, joysticks etc.) to indicate the value of the modification parameter (particularly when the user is trying to exceed the range of modification indicated by the modification parameter) in the absence of the GUIs 32, 34.

Although not shown in examples of FIGS. 3A to 3C, it will be appreciated that other information may be displayed to the user via the GUI 30, 32, 34. For instance, a current (or intended) level of modification for one or more of the temporal frames may be indicated relative to the indicators corresponding to those temporal frames. The indicators 301A-F may also or alternatively indicate different ranges of modification for each temporal frame based on the degradation of the quality of the modified composite signal that is associated with different ranges. For instance, the indicators may indicate a first range in which the degradation in quality would be low, a second range in which the degradation in quality would be higher but still acceptable and a third range in which the degradation in quality would be unacceptable. The different ranges may for instance be indicated using different colours (e.g. green, yellow and red).

Although also not shown in example of FIGS. 3A to 3C, the GUIs 30, 32, 34 may include a function for allowing the user to preview the modified composite audio signal, for instance in combination with a correspondingly modified version of a signal derived from the one of the additional audio capture device which corresponds to the separated sound source. In this way, the user may be able verify the quality of the modified composite signal before confirming the modifications via the GUI.

As will be appreciated, repositioning of sound sources may be performed in one, two or three dimensions. The re-positioning may be performed in a Cartesian coordinate system with x, y, and z axis, or in a polar coordinate system with azimuth, elevation and distance. The GUIs may thus be configured in dependence on the number of dimensions (and coordinate system) in which the positioning is to be performed.

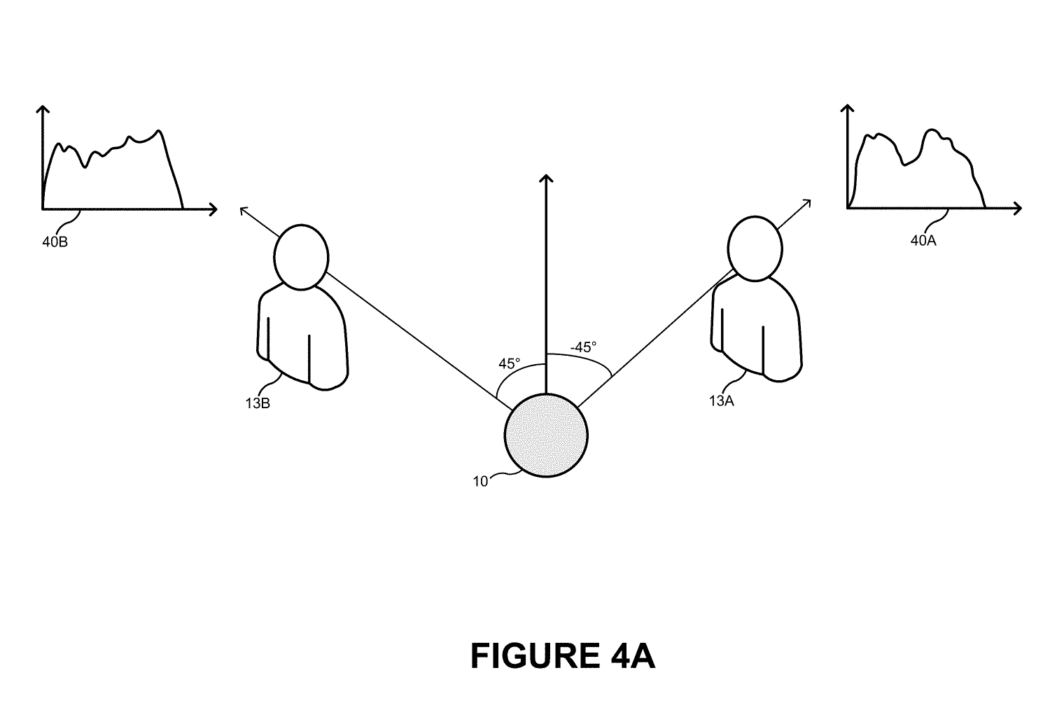

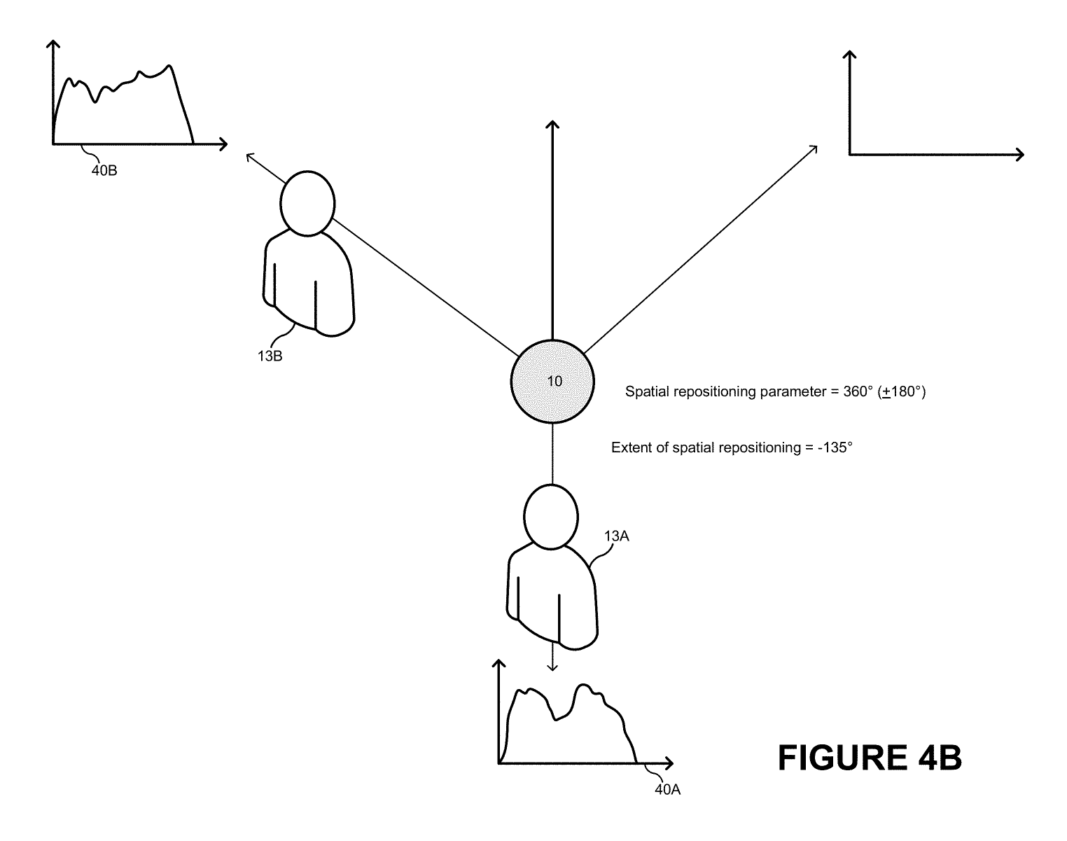

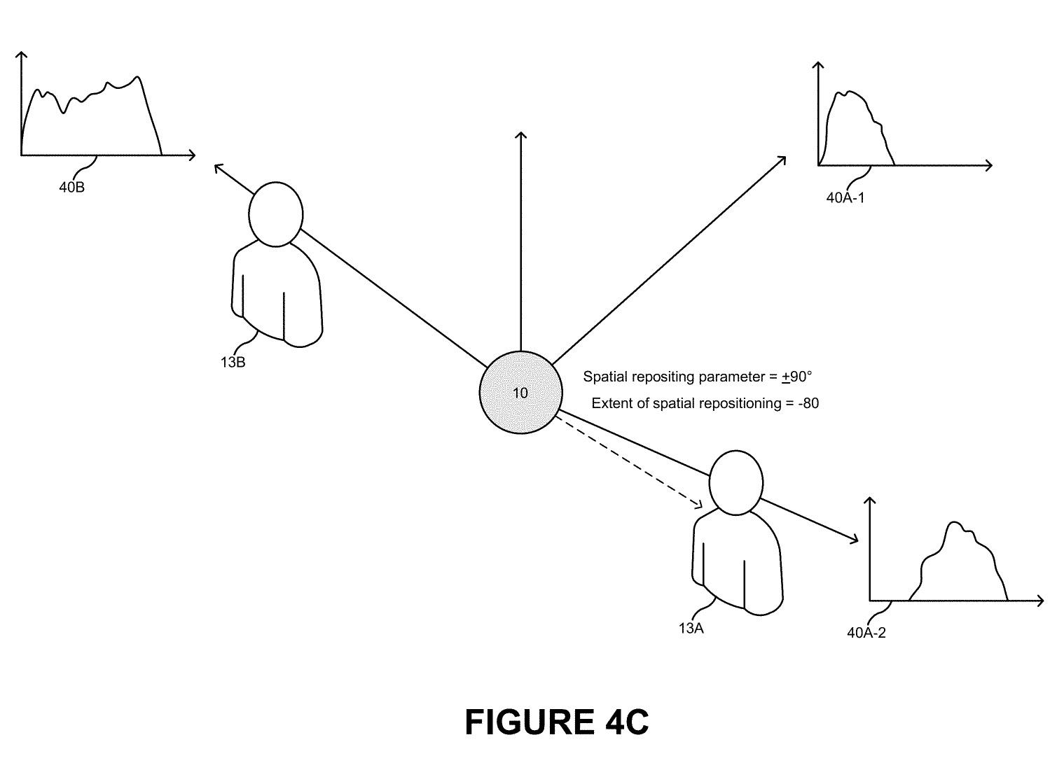

Referring now to FIGS. 4A to 4C, these figures serve to illustrate the way in which a value of a spatial repositioning parameter may be determined on the basis of the success of a separation from a composite audio signal.

FIG. 4A illustrates two sound sources (in this example, two people 13A, 13B speaking) at different spatial positions relative to the location of the spatial audio capture device 10 (which may also be the location of the listener when the audio is being rendered).

A first speaker 13A is located at an azimuthal angle of −45 degrees which is to the left of the capture device/listener and a second speaker 13B is located at an azimuthal angle of +45 degrees which is to the right of the capture device/listener.

Frequency spectra 40A, 40B of the voice signals (sound sources) for each speaker have been depicted in their relative spatial positions. The frequency spectrum describes the frequency distribution of the voice signal/sound source. As discussed above, however, it should be appreciated that the frequency spectrum varies over time and, as such, FIG. 4A depicts an instantaneous situation in a short-time time frame, for instance and duration of 20 milliseconds.

FIG. 4B illustrates a fully successful separation of the frequency spectra from the composite audio signal. In this example, this is indicated by the fact that none of the components of the signal derived from the sound source remain at the original location. In such a situation, the audio processing apparatus 14 may determine that the degree of success is above the success threshold and so may set the value of the spatial repositioning parameter to indicate that the full range of spatial repositioning may be performed. In this example, the full range of repositioning is 360 degrees and so this is indicated by the spatial repositioning parameter.

As can be seen, in this example, the sound source corresponding to the first speaker 13A (indicated by frequency spectra 40A) has been repositioned within the allowed range by minus 135 degrees to minus 180 degrees which is behind the capture apparatus/listener.

In contrast to FIG. 4B, FIG. 4C illustrates a situation in which the separation has not been fully successful. This is indicated in FIG. 4C by various components 40A-1 of the frequency spectrum 40A of the first speaker 13A being left in their original location while other components 40A-2 have been separated.

In an example such as that illustrated in FIG. 4C, the audio processing apparatus 14 determines that the separation has not been fully successful. As such, the audio processing apparatus 14 determines a value of the spatial repositioning parameter based on the degree of success of the separation. The determination of the value of the spatial repositioning parameter may be such that a higher degree of success results in the spatial repositioning parameter having a value which indicates a higher range of spatial repositioning and a lower degree of success results in the spatial repositioning parameter having a value which indicates a lower range of spatial repositioning.

In the example of FIG. 4C, the value of the spatial repositioning parameter indicates that the separated sound source may be repositioned by ±90 degrees from its original location. In view of this, the separated signal 40A-2 has been repositioned within the range indicated by the spatial repositioning parameter by −80 degrees. As such, the quality of the resulting modified composite audio signal is not degraded beyond an acceptable level.

In the above examples described with reference to FIGS. 1 to 4C, the composite signal from which the identified sounds source has been separated is generated by a spatial audio capture apparatus 10. However, it will of course be appreciated that methods and operations described herein may be performed in respect of any audio signal which includes components derived from a plurality of audio sources, for instance a signal derived from one of the additional audio capture devices which happens to include components from two speakers (e.g. because both speakers are in sufficiently close proximity to the capture device).

Although the above examples have been discussed primarily with reference to the modification of characteristics of a separated audio signal, it should be appreciated that various operations described herein may be applied to signals comprising both audio and visual (AV) components. For instance, spatial repositioning could be applied to the portions of the visual component of the AV signal. For example, the audio processing apparatus 14 may be configured to identify and reposition a visual object in visual components which corresponds to the separated sound source. More specifically, the audio processing apparatus 14 may be configured to segment (or separate) the visual object corresponding to the separated sound source from the remainder of the video component and substitute the background. The audio processing apparatus 14 may be configured subsequently to allow repositioning of the separated visual object based on the determined spatial repositioning parameter for the separated audio signal.

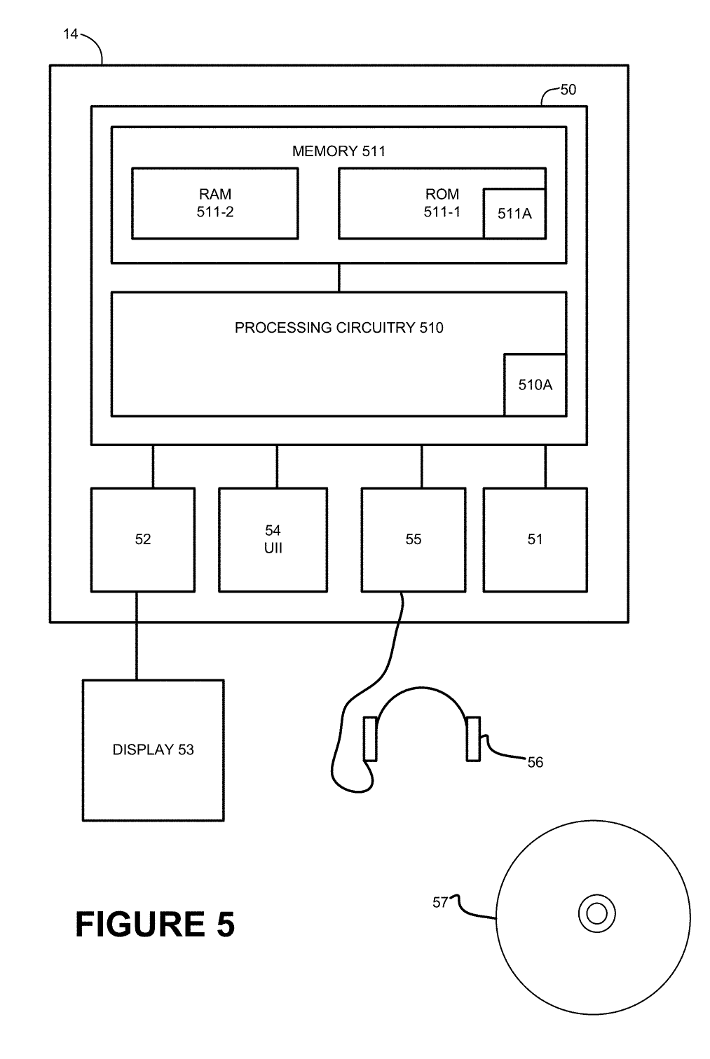

FIG. 5 is a schematic block diagram illustrating an example configuration of the audio processing apparatus 14 described with reference to FIGS. 1 to 4C.

The audio processing apparatus 14 comprises control apparatus 50 which is configured to perform various operations as described above with reference to the audio processing apparatus 14. The control apparatus 50 may be further configured to control the other components of the audio processing apparatus 14.

The audio processing apparatus 14 may further comprise a data input interface 51, via which signals representative of the composite audio signal may be received. Signals derived from the one or more additional audio capture devices 12A-C may also be received via the data input interface 51. The data input interface 51 may be any suitable type of wired or wireless interface. Data representative of the visual components captured by the spatial audio capture apparatus 10 may also be received via the data input interface 51.

The audio processing apparatus 14 may further comprise a visual output interface 52, which may be coupled to a display 53. The control apparatus 50 may cause information indicative of the value of the separated signal modification parameter to be provided to the user via the visual output interface 52 and the display 53. The control apparatus 50 may additionally cause a GUI 30, 32, 34 such as those described with reference to FIGS. 3A, 3B and 3C to be displayed for the user. Video components which correspond to the audio signals may also be caused to be displayed via the visual output interface 52 and the display 53.

The audio processing apparatus 14 may further comprise a user input interface 54 via which user inputs may be provided to the audio processing apparatus 14 by a user of the apparatus.

The audio processing apparatus 14 may additionally comprise an audio output interface 55 via which audio may be provided to the user, for instance via a loudspeaker arrangement or a binaural headset 56. For instance, the modified composite audio signals may be provided to the user via the audio output interface 55.

Some further details of components and features of the above-described audio processing apparatus 14 and alternatives for them will now be described, primarily with reference to FIG. 5.

The control apparatus 51 may comprise processing circuitry 510 communicatively coupled with memory 511. The memory 511 has computer readable instructions 511A stored thereon, which when executed by the processing circuitry 510 causes the processing circuitry 510 to cause performance of various ones of the operations above described with reference to FIGS. 1 to 5. The control apparatus 51 may in some instances be referred to, in general terms, as “apparatus”.

The processing circuitry 510 of any of the audio processing apparatus 14 described with reference to FIGS. 1 to 5 may be of any suitable composition and may include one or more processors 510A of any suitable type or suitable combination of types. For example, the processing circuitry 510 may be a programmable processor that interprets computer program instructions 511A and processes data. The processing circuitry 510 may include plural programmable processors. Alternatively, the processing circuitry 510 may be, for example, programmable hardware with embedded firmware. The processing circuitry 510 may be termed processing means. The processing circuitry 510 may alternatively or additionally include one or more Application Specific Integrated Circuits (ASICs). In some instances, processing circuitry 510 may be referred to as computing apparatus.

The processing circuitry 510 is coupled to the respective memory (or one or more storage devices) 511 and is operable to read/write data to/from the memory 511. The memory 511 may comprise a single memory unit or a plurality of memory units, upon which the computer readable instructions (or code) 511A is stored. For example, the memory 511 may comprise both volatile memory 511-2 and non-volatile memory 511-1. For example, the computer readable instructions 511A may be stored in the non-volatile memory 511-1 and may be executed by the processing circuitry 510 using the volatile memory 501-2 for temporary storage of data or data and instructions. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions 511A may be pre-programmed into the audio processing apparatus 14. Alternatively, the computer readable instructions 511A may arrive at the apparatus 14 via an electromagnetic carrier signal or may be copied from a physical entity 57 (see FIG. 5) such as a computer program product, a memory device or a record medium such as a CD-ROM or DVD. The computer readable instructions 511A may provide the logic and routines that enables the audio processing apparatus 14 to perform the functionality described above. The combination of computer-readable instructions stored on memory (of any of the types described above) may be referred to as a computer program product.

Where applicable, wireless communication capability of the apparatuses 10, 12, 14 may be provided by a single integrated circuit. It may alternatively be provided by a set of integrated circuits (i.e. a chipset). The wireless communication capability may alternatively be a hardwired, application-specific integrated circuit (ASIC).

As will be appreciated, the apparatuses 10, 12, 14 described herein may include various hardware components which may not have been shown in the Figures. For instance, the audio processing apparatus 14 may in some implementations comprise a portable computing device such as a mobile telephone or a tablet computer and so may contain components commonly included in a device of the specific type. Similarly, the audio processing apparatus 14 may comprise further optional software components which are not described in this specification since they may not have relevant to the main principles and concepts described herein.

The examples described herein may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined. Similarly, it will also be appreciated that flow diagrams of FIGS. 2A to 2C are examples only and that various operations depicted therein may be omitted, reordered and or combined.

Although various aspects are set out in the independent claims, other aspects comprise other combinations of features from the described embodiments and/or the dependent claims with the features of the independent claims, and not solely the combinations explicitly set out in the claims. It is also noted herein that while the above describes various examples, these descriptions should not be viewed in a limiting sense. Rather, there are several variations and modifications which may be made without departing from the scope of the present invention as defined in the appended claims.

1. A method comprising:
determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.

2. The method according to claim 1, wherein the separated signal modification parameter is a spatial repositioning parameter which indicates a range of spatial repositioning for spatial repositioning of the separated audio signal.

3. The method according to claim 1, comprising determining the measure of success of the separation of the audio signal from the composite audio signal.

4. The method according to claim 1, comprising:
limiting an allowed amount of modification of the characteristic associated with the separated audio signal based on the value of the separated signal modification parameter.

5. The method according to claim 1, comprising:
causing an indication of the determined value of the separated signal modification parameter to be provided to a user.

6. The method according to claim 1, comprising:
when the measure of success indicates that success of the separation is above a threshold degree of success, determining a value of the separated signal modification parameter which indicates a full range of modification of the characteristic.

7. The method according to claim 1 wherein, when the measure of success indicates that the success of the separation is below a threshold degree of success, the determined value of the separated signal modification parameter indicates a range of modification which has a direct relationship with the degree of success.

8. The method according to claim 1, wherein the measure of success comprises a correlation between a remainder of the composite audio signal and at least one reference audio signal.

9. The method according to claim 8, comprising:
if the correlation is a below the predetermined threshold correlation, determining a value of the separated signal modification parameter which indicates a full range of modification;
if the correlation is above the predetermined threshold correlation, determining a value of the separated signal modification parameter which indicates a range of modification which has an inverse relationship with the correlation.

10. The method according to claim 1 wherein the measure of success of the separation comprises a correlation between a frequency spectrum associated with the remainder of the composite audio signal and a frequency spectrum associated with the reference audio signal.

11. The method according to claim 1, wherein the measure of success of the separation comprises a correlation between a remainder of composite audio signal and a component of a video signal corresponding to the composite audio signal.

12. An apparatus comprising at least one processor and at least one memory including computer program code, which when executed by the at least one processor, cause the apparatus to:
determine, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.

13. The apparatus according to claim 12, wherein:
the separated signal modification parameter is a spatial repositioning parameter which indicates a range of spatial repositioning for spatial repositioning of the separated audio signal.

14. The apparatus according to claim 12, wherein
the computer program code, when executed by the at least one processor, further cause the apparatus to:
determine the measure of success of the separation of the audio signal from the composite audio signal.

15. The apparatus according to claim 12, wherein
the computer program code, when executed by the at least one processor, further cause the apparatus to:
limit an allowed amount of modification of the characteristic associated with the separated audio signal based on the value of the separated signal modification parameter.

16. The apparatus according to claim 12, wherein
the computer program code, when executed by the at least one processor, further cause the apparatus to:
cause an indication of the determined value of the separated signal modification parameter to be provided to a user.

17. The apparatus according to claim 12, wherein
the computer program code, when executed by the at least one processor, further cause the apparatus to:
determine a value of the separated signal modification parameter which indicates a full range of modification of the characteristic, when the measure of success indicates that success of the separation is above a threshold degree of success.

18. The apparatus according to claim 12, wherein the measure of success comprises a correlation between a remainder of the composite audio signal and at least one reference audio signal.

19. The apparatus according to claim 18, wherein
the computer program code, when executed by the at least one processor, further cause the apparatus to:
if the correlation is a below the predetermined threshold correlation,
determine a value of the separated signal modification parameter which indicates a full range of modification and;
if the correlation is above the predetermined threshold correlation,
determine a value of the separated signal modification parameter which indicates a range of modification which has an inverse relationship with the correlation.

20. A computer-readable medium having computer-readable code stored thereon, the computer readable code, when executed by at least one processor, causing performance of at least:
determining, based on a determined measure of success of a separation of an audio signal representing a sound source from a composite audio signal comprising components derived from at least two sound sources, a value of a separated signal modification parameter, the value of the separated signal modification parameter indicating a range of modification of a characteristic associated with the separated audio signal.
